(19) United States
(12) Patent Application Publication
(10) Pub. No.: US 2025/0306607 A1
(43) Pub. Date: Oct. 2, 2025

(54) TOWING ASSISTANCE APPARATUS

(71) Applicant: AISIN CORPORATION, Kariya (JP)

(72) Inventors: Daisuke SATO, Kariya-shi (JP); Atsuto OGINO, Kariya-shi (JP)

(73) Assignee: AISIN CORPORATION, Kariya (JP)

(21) Appl. No.: 19/081,099

(22) Filed: Mar. 17, 2025

(30) Foreign Application Priority Data
Mar. 29, 2024 (JP) 2024-057634

(51) Int. Cl. G05D 1/672; G05D 1/646; G05D 109/10

(52) U.S. Cl. CPC G05D 1/672; G05D 1/646; G05D 2109/16

(57) ABSTRACT

A towing assistance apparatus assists backward traveling of a towing vehicle towing a towed vehicle. The towing assistance apparatus includes: a target path calculation unit configured to calculate a target path on which the towed vehicle is to be moved; an acquisition unit configured to acquire coordinates of the towed vehicle in a planar coordinate system and a coupling angle between the towed vehicle and the towing vehicle; a calculation unit configured to calculate first target curvature that is target curvature of the towed vehicle used for feedforward control based on the target path; a first conversion unit configured to convert the first target curvature into second target curvature that is target curvature of the towing vehicle; and a second conversion unit configured to convert the second target curvature into a target steering angle of the towing vehicle.

### CROSS REFERENCE TO RELATED APPLICATIONS

This application is based on and claims priority under 35 U.S.C. § 119 to Japanese Patent Application 2024-057634, filed on Mar. 29, 2024, the entire content of which is incorporated herein by reference.

### TECHNICAL FIELD

This disclosure relates to a towing assistance apparatus.

### BACKGROUND DISCUSSION

There is known an apparatus for performing towing assistance in a towing vehicle such as a tractor for towing a towed vehicle such as a trailer. For example, during towing assistance when the towed vehicle is towed backward, a towing assistance apparatus calculates a target path for the towed vehicle in advance, and controls the towing vehicle such that the towed vehicle moves on the calculated target path.

For example, according to a technique in JP 2022-107175A (Reference 1), a data series of an attitude angle and a steering angle of a towing vehicle and a towed vehicle is calculated in advance by simulation, and is used for feedforward control and feedback control in a case where the towing vehicle and the towed vehicle are moved backward.

However, since the technique in Reference 1 described above is a method in which the data series is calculated and retained by performing the simulation in advance, calculation cost is high and memory consumption is large. In addition, the feedback control is performed for three state variables, that is, lateral deviation, yaw angle deviation, and hitch angle deviation, a steering control logic is complex, and gain adjustment is difficult.

A need thus exists for a towing assistance apparatus which is not susceptible to the drawback mentioned above.

### SUMMARY

A towing assistance apparatus according to an embodiment is a towing assistance apparatus that assists backward traveling of a towing vehicle towing a towed vehicle, the towing assistance apparatus including: a target path calculation unit configured to calculate a target path on which the towed vehicle is to be moved; an acquisition unit configured to acquire coordinates of the towed vehicle in a planar coordinate system and a coupling angle between the towed vehicle and the towing vehicle; a calculation unit configured to calculate first target curvature that is target curvature of the towed vehicle used for feedforward control based on the target path; a first conversion unit configured to convert the first target curvature into second target curvature that is target curvature of the towing vehicle; and a second conversion unit configured to convert the second target curvature into a target steering angle of the towing vehicle.

### BRIEF DESCRIPTION OF THE DRAWINGS

The foregoing and additional features and characteristics of this disclosure will become more apparent from the following detailed description considered with the reference to the accompanying drawings, wherein:

FIG. 1 is a side view showing a tractor and a trailer according to an embodiment;

FIG. 2 is a top view showing the tractor and the trailer according to the embodiment;

FIG. 3 shows an example of a configuration of a towing assistance system provided in the tractor according to the embodiment;

FIG. 4 is a block diagram showing an example of a functional configuration of a towing assistance apparatus according to the embodiment;

FIG. 5 shows a trailer position acquired by the towing assistance apparatus according to the embodiment;

FIG. 6 shows a nearest point calculated by the towing assistance apparatus according to the embodiment;

FIG. 7 shows a distance used by the towing assistance apparatus according to the embodiment; and

FIG. 8 is a block diagram showing an example of a functional configuration of a towing assistance apparatus according to a modification of the embodiment.

### DETAILED DESCRIPTION

Hereinafter, an embodiment of a towing assistance apparatus disclosed here will be described in detail with reference to the accompanying drawings.

### Configuration Examples of Tractor and Trailer

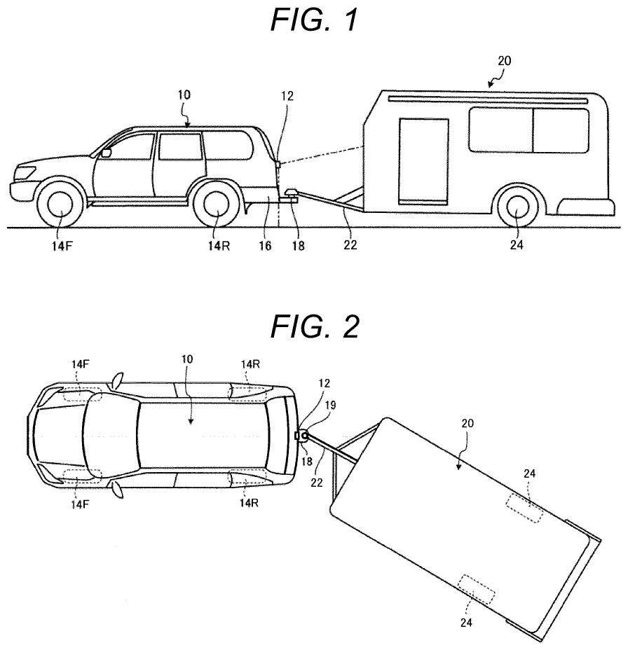

FIG. 1 is a side view showing a tractor 10 and a trailer 20 according to the embodiment. FIG. 2 is a top view showing the tractor 10 and the trailer 20 according to the embodiment. In FIGS. 1 and 2, the tractor 10 is used as a reference, a left direction on the page is defined as the front (forward traveling direction), and a right direction on the page is defined as the rear (backward traveling direction). The tractor 10 is an example of a towing vehicle, and the trailer 20 is an example of a towed vehicle towed by the towing vehicle such as the tractor 10.

The tractor 10 may be, for example, a vehicle such as an internal combustion engine automobile using an internal combustion engine (engine) as a drive source, a vehicle such as an electric automobile or a fuel cell automobile using an electric motor (motor) as a drive source, or a vehicle such as a hybrid automobile using both of the internal combustion engine and the electric motor as a drive source. Therefore, the tractor 10 can be equipped with various transmission apparatuses, and can also be equipped with various apparatuses, systems, and components necessary for driving the internal combustion engine or the electric motor.

The tractor 10 may also be a sport utility vehicle (SUV) as shown in FIG. 1, a so-called “pickup truck” with a cargo bed provided on a rear side of the vehicle, or a general passenger vehicle.

The tractor 10 includes, for example, four wheels 14 including a pair of front wheels 14F and a pair of rear wheels 14R. The tractor 10 in the embodiment is, for example, a rear-wheel drive vehicle driven by the rear wheels 14R. A method, a number, a layout, and the like related to driving of the wheels 14 of the tractor 10 can be set in various manners.

An imaging unit 12 is provided at a rear lower wall portion of the tractor 10. The imaging unit 12 is, for example, a digital camera including an imaging element such as a charge-coupled device (CCD) or a CMOS image sensor (CIS), and is a rear camera that captures an image in the backward traveling direction (rear side) of the tractor 10.

The imaging unit 12 sequentially captures images of a region including a rear end of the tractor 10, a coupling member 22 that couples the tractor 10 and the trailer 20, and at least a front end of the trailer 20, which is a range indicated by, for example, dash-double-dot lines in FIG. 1. An image captured with the imaging unit 12 can be used to detect a coupling angle representing a tilt of the trailer 20 in a left-right direction relative to the tractor 10. The coupling angle is also referred to as a hitch angle to be described later.

The tractor 10 may include a plurality of imaging units that capture images of a lateral side or a front side of the tractor 10 in order to check a situation around the tractor 10. An imaging unit may also be provided on a lateral side or a rear side of the trailer 20. Computational processing and image processing may be performed based on captured image data obtained with the plurality of imaging units to generate an image having a wider viewing angle or generate a virtual overhead image of the tractor 10 viewed from above.

A hitch 18 that is a towing apparatus for towing the trailer 20 protrudes from a lower portion of a central portion of a rear bumper 16 of the tractor 10 in a vehicle width direction, for example. The hitch 18 is fixed to, for example, a frame of the tractor 10. The hitch 18 includes, as an example, a hitch ball 19 having a spherical tip portion erected in a vertical direction (vehicle up-down direction), and a coupler provided at a tip end of the coupling member 22 fixed to the trailer 20 covers the hitch ball 19. As a result, the tractor 10 and the trailer 20 are coupled to each other, and the trailer 20 is rotatable in the vehicle width direction relative to the tractor 10. That is, the hitch ball 19 transmits movement in front-rear and left-right directions to the trailer 20 via the hitch 18, and receives power for acceleration or deceleration.

The trailer 20 may be, for example, as shown in FIG. 1, a box-type trailer including at least one of a passenger space, a living section, and a storage space, or may be a flatbed type trailer on which cargo such as a container or a boat is placed. The trailer 20 shown in FIG. 1 includes a pair of wheels 24, as an example. The trailer 20 in the embodiment is assumed to be a driven vehicle including driven wheels that include no drive wheel nor steered wheel.

### Configuration Example of Towing Assistance System

The tractor 10 in the embodiment is equipped with, for example, a towing assistance system 100. The towing assistance system 100 assists driving of the tractor 10 towing the trailer 20.

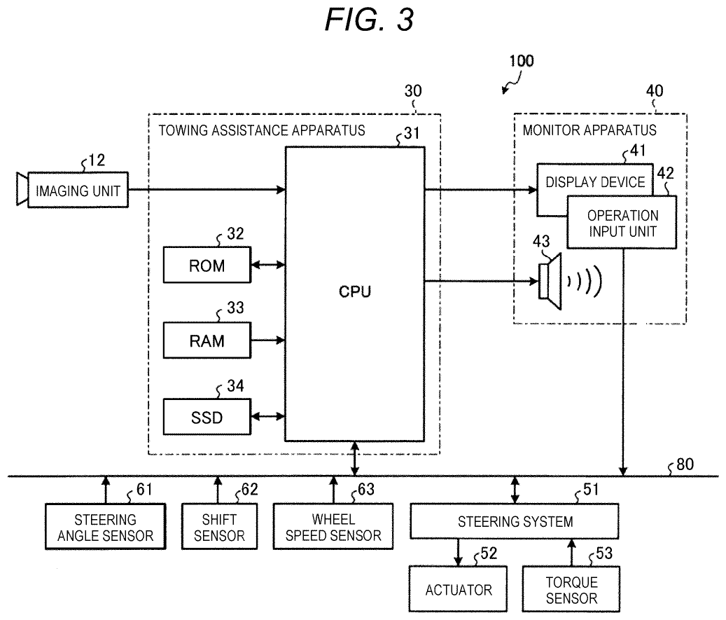

FIG. 3 shows an example of a configuration of the towing assistance system 100 provided in the tractor 10 according to the embodiment. As shown in FIG. 3, the towing assistance system 100 includes a towing assistance apparatus 30, a monitor apparatus 40, a steering system 51, an actuator 52, a torque sensor 53, a steering angle sensor 61, a shift sensor 62, a wheel speed sensor 63, and the imaging unit 12.

In the towing assistance system 100, the towing assistance apparatus 30, the monitor apparatus 40, the steering system 51, the steering angle sensor 61, the shift sensor 62, and the wheel speed sensor 63 are electrically connected via an in-vehicle network 80 such as an electric communication line. The in-vehicle network 80 is implemented as, for example, a controller area network (CAN).

The towing assistance apparatus 30 is, for example, an electronic control unit (ECU), and is implemented as a computer including a central processing unit (CPU) 31, a read-only memory (ROM) 32, a random access memory (RAM) 33, and a solid-state drive (SSD) 34.

The CPU 31 can read a program installed and stored in a non-volatile storage apparatus such as the ROM 32 and perform computational processing according to the program. The RAM 33 temporarily stores various types of data used in the computation of the CPU 31. The SSD 34 is a rewritable non-volatile storage unit, and can store data even when the towing assistance apparatus 30 is powered off.

The CPU 31, the ROM 32, the RAM 33, and the like may be integrated in the same package. The towing assistance apparatus 30 may be implemented using another logical operation processor such as a digital signal processor (DSP), or a logic circuit instead of the CPU 31. In addition, a hard disk drive (HDD) may be provided instead of the SSD 34, and the SSD 34 or the HDD may be provided separately from the towing assistance apparatus 30.

The towing assistance apparatus 30 can control the steering system 51 and the like by transmitting a control signal through the in-vehicle network 80. The towing assistance apparatus 30 can receive detection results from the torque sensor 53, the steering angle sensor 61, the shift sensor 62, the wheel speed sensor 63, and the like via the in-vehicle network 80. The CPU 31 provided in the towing assistance apparatus 30 can receive an operation signal or the like from an operation input unit 42 or the like provided in the monitor apparatus 40, and can output a control signal or the like to a display device 41, an audio output device 43, or the like. The CPU 31 also receives the image captured by the imaging unit 12.

The monitor apparatus 40 includes the display device 41, the operation input unit 42, and the audio output device 43, and is disposed at a central portion of a dashboard in the vehicle width direction (left-right direction).

The display device 41 is, for example, a liquid crystal display (LCD) or an organic electroluminescent display (OELD). The display device 41 can display the image captured by the imaging unit 12, for example, when the trailer 20 is pushed back by the tractor 10 that travels backward and is towed backward under control of the towing assistance apparatus 30.

The display device 41 is covered with the operation input unit 42 such as a transparent touch panel. A driver of the tractor 10 can visually recognize an image displayed on a screen of the display device 41 via the operation input unit 42. The driver can issue various instructions to the towing assistance apparatus 30 by touching, pressing, or moving the operation input unit 42 with a finger or the like at a position corresponding to the image displayed on the screen of the display device 41.

As an example, the driver can instruct the towing assistance apparatus 30 to start towing assistance by operating the operation input unit 42. At this time, the driver may be capable of selecting at least one of a backward movement assistance mode, a forward movement assistance mode, and a parking assistance mode, for example.

The backward movement assistance mode is selected when the trailer 20 is towed backward by the tractor 10. The forward movement assistance mode is selected when the trailer 20 is towed forward by the tractor 10. The parking assistance mode is selected when parking the tractor 10 that tows the trailer 20. The towing assistance apparatus 30 performs towing assistance according to the selected mode.

The audio output device 43 is, as an example, a speaker.

The monitor apparatus 40 may also be used as a navigation system, an audio system, or the like, or may be provided separately from such systems.

The steering system 51 is, for example, an electric power steering system or a steer-by-wire (SBW) system, and includes the actuator 52 and the torque sensor 53.

The steering system 51 causes the actuator 52 to add torque, that is, assist torque, to a steering unit such as a steering wheel to supplement a steering force, or causes the actuator 52 to steer the wheels 14. In the tractor 10 in the embodiment, the front wheels 14F are steerable wheels. The actuator 52 may steer one wheel 14 or a plurality of wheels 14.

The steering system 51 is electrically controlled by the towing assistance apparatus 30 or the like, or operates the actuator 52 according to an operation performed by the driver on the steering unit such as the steering wheel. The torque sensor 53 detects, for example, torque applied to the steering unit by the driver.

The steering angle sensor 61 is, for example, an angle sensor that detects a steering amount of the steering unit such as the steering wheel. The steering amount of the steering unit is a steering angle of the tractor 10. The steering angle sensor 61 is implemented using, for example, a Hall element, and detects a rotation angle of a rotating portion provided in the steering unit. The towing assistance apparatus 30 acquires a steering amount of the steering unit by the driver, a steering amount of the wheels 14 during automated steering, and the like from the steering angle sensor 61, and performs various types of control.

The shift sensor 62 is, for example, a sensor that detects a position of a movable portion of a shift operation unit such as a shift lever. The shift sensor 62 can detect a position of a lever, an arm, a button, or the like as the movable portion. The shift sensor 62 may include a displacement sensor or may be implemented as a switch.

The wheel speed sensor 63 is a sensor that detects an amount of rotation of the wheels 14 and a rotation speed per unit time. The wheel speed sensor 63 is disposed on each wheel 14, and outputs the number of wheel speed pulses indicating a rotation speed detected at each wheel 14 as a sensor value. The wheel speed sensor 63 may include, for example, a Hall element. The towing assistance apparatus 30 calculates a movement amount of the tractor 10 based on the sensor value acquired from the wheel speed sensor 63, and performs various types of control.

Configurations, arrangements, electrical connection forms, and the like of the various sensors and actuators described above are merely examples, and can be set in various ways.

### Configuration Example of Towing Assistance Apparatus

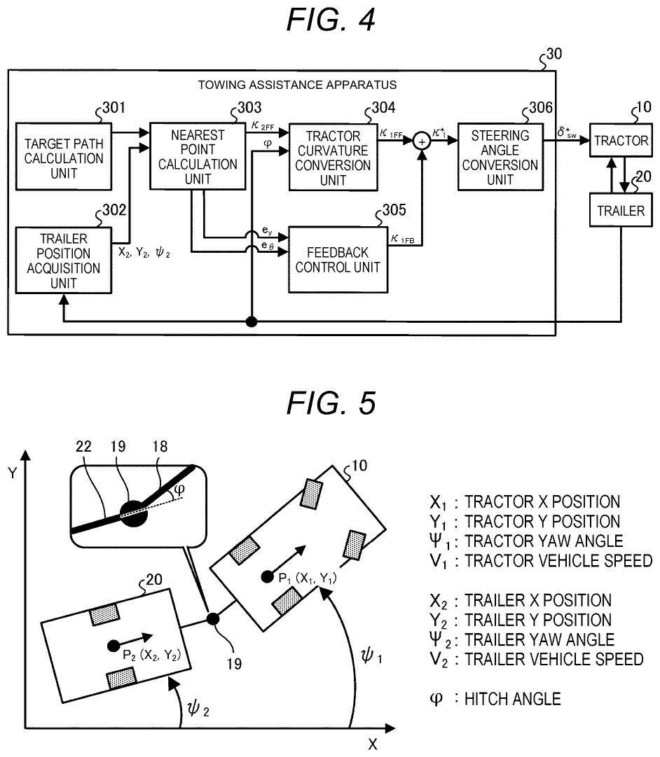

Next, an example of a functional configuration of the towing assistance apparatus 30 in the embodiment will be described with reference to FIGS. 4 to 7.

FIG. 4 is a block diagram showing the example of the functional configuration of the towing assistance apparatus 30 according to the embodiment. As shown in FIG. 4, the towing assistance apparatus 30 includes, as functional units, a target path calculation unit 301, a trailer position acquisition unit 302, a nearest point calculation unit 303, a tractor curvature conversion unit 304, a feedback control unit 305, and a steering angle conversion unit 306.

These functional units of the towing assistance apparatus 30 are implemented by the CPU 31 by loading a program stored in the ROM 32 or the like into the RAM and executing the program. The program executed by the CPU 31 may be provided by being recorded on a computer-readable storage medium such as a CD-ROM, a flexible disk (FD), a CD-R, a digital versatile disk (DVD), or a universal serial bus (USB) as a file in an installable or executable format, or may be provided or distributed via a network such as the Internet. Various programs may be provided by being embedded in a non-volatile storage medium such as a ROM in advance.

However, what is disclosed here is not limited to the above-described embodiment, and at least a part of the above-described functional units may be implemented using a dedicated hardware circuit.

Hereinafter, an example will be described in which the driver selects the backward movement assistance mode or the like and the towing assistance apparatus 30 assists backward movement of the tractor 10 that tows the trailer 20. In the backward movement assistance of the tractor 10, the towing assistance apparatus 30 calculates a target path serving as a movement path for the trailer 20, and controls, for example, steering of the tractor 10 such that the trailer 20 moves on the target path.

The target path calculation unit 301 calculates the target path for the trailer 20 when the towing assistance apparatus 30 starts the backward movement assistance.

The trailer position acquisition unit 302 sequentially acquires an X-direction position X₂, a Y-direction position Y₂, and a yaw angle ψ₂ of the trailer 20 shown in FIG. 5 during the backward movement assistance by the towing assistance apparatus 30.

FIG. 5 shows a trailer position P₂ acquired by the towing assistance apparatus 30 according to the embodiment. As shown in FIG. 5, for example, by placing the tractor 10 and the trailer 20 on absolute coordinates of an X coordinate and a Y coordinate, the trailer position P₂ and a tractor position P₁ can be represented. That is, the tractor position P₁ is represented by an X-direction position X₁ and a Y-direction position Y₁ of the tractor 10, and a yaw angle ψ₁ that is a tilt of the tractor 10 from an X-axis of the absolute coordinates, for example. The trailer position P₂ is represented by the X-direction position X₂ and the Y-direction position Y₂ of the trailer 20, and the yaw angle ψ₂ that is a tilt of the trailer 20 from the X-axis of the absolute coordinates, for example.

Here, the tractor position P₁ is determined based on, for example, a center point of the pair of rear wheels 14R that are drive wheels of the tractor 10, that is, a midpoint of an axle of the rear wheels 14R. The trailer position P₂ is determined based on, for example, a center point of the pair of wheels 24 of the trailer 20, that is, a midpoint of an axle of the wheels 24.

However, for example, in the case of a two-axle trailer including two pairs of wheels, the trailer position may be determined with reference to a midpoint of a first axle or a second axle or with reference to any point between the midpoint of the first axle and the midpoint of the second axle.

The X-direction position X₁, the Y-direction position Y₁, and the yaw angle ψ₁ of the tractor 10 in the absolute coordinates can be detected, for example, using the steering angle sensor 61, the shift sensor 62, and the wheel speed sensor 63. The X-direction position X₂, the Y-direction position Y₂, and the yaw angle ψ₂ of the trailer 20 in the absolute coordinates can be specified based on the tractor position P₁ and a hitch angle q.

As shown in FIG. 5, the hitch angle q is an angle formed by a line which is a center line of the trailer 20 in the left-right direction and which is a line obtained by extending a line coinciding with an extending direction of the coupling member 22 further forward along the coupling member 22, and a center line of the tractor 10 in the left-right direction. The hitch angle q can be specified by analyzing the image captured by the imaging unit 12 described above, for example. The method is not limited to image recognition, and alternatively, for example, a sensor for detecting the hitch angle ϕ may be provided for the hitch ball 19.

In this way, the tractor position P₁ such as the X-direction position X₁, the Y-direction position Y₁, and the yaw angle ψ₁ of the tractor 10, and the hitch angle φ are specified. Further, by using a distance between the front and rear wheels 14F and 14R of the tractor 10, a distance from each rear wheel 14R of the tractor 10 to the hitch ball 19, and a distance from the hitch ball 19 to each wheel 24 of the trailer 20, which are known values, the trailer position P₂ such as the X-direction position X₂, the Y-direction position Y₂, and the yaw angle ψ₂ of the trailer 20 can be specified.

The nearest point calculation unit 303 calculates deviation of a current position of the trailer 20 from the target path based on the target path of the trailer 20 calculated by the target path calculation unit 301 and the trailer position P₂ acquired by the trailer position acquisition unit 302, and further calculates target curvature K_{2FF} of the trailer 20.

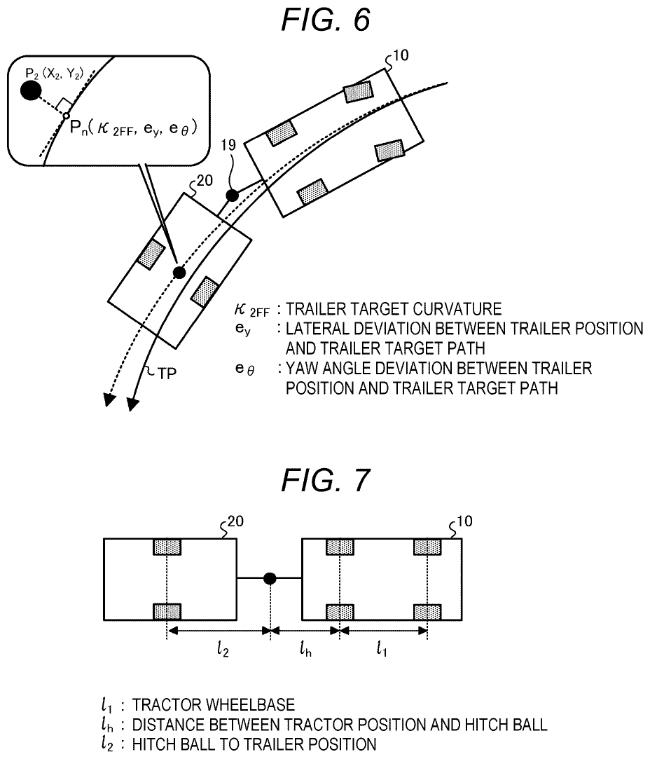

FIG. 6 shows a nearest point Pₙ calculated by the towing assistance apparatus 30 according to the embodiment. As shown in FIG. 6, the deviation of the current position of the trailer 20 from the target path is represented by, for example, the nearest point Pₙ of a target path TP of the trailer 20 relative to the trailer position P₂. That is, the nearest point Pₙ is a point on the target path TP where a distance to the trailer position P₂ is shortest, and is a point of intersection when a perpendicular line is dropped from the trailer position P₂ to a tangent line of the curved target path TP. The nearest point Pₙ is represented by lateral deviation e_{y} between the trailer position P₂ and the target path TP, and yaw angle deviation e_{θ} between the trailer position P₂ and the target path TP.

The target curvature K_{2FF} of the trailer 20 is target curvature of the trailer 20 when feedforward control for moving the position of the trailer 20 along the target path TP is performed, and is calculated based on the nearest point Pₙ represented by the lateral deviation e_{y} and the yaw angle deviation e_{θ} of the trailer 20.

The target curvature K_{2FF} of the trailer 20 used for the feedforward control for maintaining the trailer position P₂ on the target path TP is an example of first target curvature.

The tractor curvature conversion unit 304 converts the target curvature K_{2FF} of the trailer 20 calculated by the nearest point calculation unit 303 into target curvature K_{1FF} of the tractor 10. The target curvature K_{1FF} of the tractor 10 is target curvature of the tractor 10 when the feedforward control for maintaining the position of the trailer 20 on the target path TP is performed, and is calculated using the following equation (1) using the target curvature K_{2FF} of the trailer 20 and the hitch angle φ that is also used for specifying the trailer position P₂.

$${κ}_{1 FF} = \frac{tan φ - {κ}_{2 FF} {l}_{2}}{{κ}_{2 FF} {l}_{h} {l}_{2} tan φ + {l}_{n}} \qquad ( 1 )$$

FIG. 7 shows distances Iₙ and I₂ in equation (1).

FIG. 7 shows distances I₁, Iₕ, and I₂ used by the towing assistance apparatus 30 according to the embodiment. As shown in FIG. 7, the distance I₁ is a wheelbase of the tractor 10, that is, a distance between the front and rear wheels 14F and 14R. The distance Iₙ is a distance from the tractor position P₁, that is, the midpoint of the axle of the rear wheels 14R of the tractor 10 to the hitch ball 19. The distance 12 is a distance from the hitch ball 19 to the trailer position P₂, that is, the midpoint of the axle of the wheels 24 of the trailer 20.

The distances Iₙ and I₂ are used to calculate the target curvature K_{1FF} of the tractor 10 using the above equation (1), and the distances I₁, Iₕ, and I₂ are also used when the trailer position acquisition unit 302 specifies the trailer position P₂ based on the tractor position P₁ and the hitch angle φ as described above.

A conversion equation from the target curvature K_{2FF} of the trailer 20 to the target curvature K_{1FF} of the tractor 10 shown in the above equation (1) is determined based on a geometric model in a tractor-trailer system and can be easily derived.

The tractor curvature conversion unit 304 is an example of a first conversion unit, and the target curvature K_{1FF} of the tractor 10 obtained by converting the target curvature K_{2FF} of the trailer 20 is an example of second target curvature.

The feedback control unit 305 calculates target curvature K_{1FB} of the tractor 10 using the lateral deviation e_{y} and the yaw angle deviation e_{θ} of the trailer 20 at the nearest point Pₙ calculated by the nearest point calculation unit 303. The target curvature K_{1FB} of the tractor 10 is target curvature of the tractor 10 when performing feedback control for returning the position of the trailer 20, where the deviation occurs, to the target path TP. The target curvature K_{1FB} of the tractor 10 calculated by the feedback control unit 305 is an approximate value.

The target curvature K_{1FB} of the tractor 10 used for the feedback control for correcting the trailer position P₂ based on the lateral deviation e_{y} and the yaw angle deviation e_{θ} of the trailer 20 is an example of third target curvature.

The steering angle conversion unit 306 calculates a target steering angle δ*_{sw} of the tractor 10 based on target curvature K′1 of the tractor 10 obtained by summing up the target curvature K_{1FF} of the tractor 10 used for the feedforward control for correcting the trailer position P₂ and the target curvature K_{1FB} of the tractor 10 used for the feedback control, and outputs the calculated target steering angle δ**_{sw} to the tractor 10. The target steering angle δ ′sw of the tractor 10 is a steering angle to be taken by the tractor 10 in order to cause the tractor 10 to travel on a path having the target curvature K′1.

The steering angle conversion unit 306 is an example of a second conversion unit.

Accordingly, the tractor 10 is controlled to have the target steering angle δ*_{sw}, and travels on a path having the target curvature K′1. Accordingly, the position of the trailer 20 can be maintained on the target path TP.

### Overview

The towing assistance apparatus assists towing of the tractor or the like for towing the trailer. For example, in the towing assistance when the trailer is towed backward by the tractor, the towing assistance apparatus calculates the target path for the trailer and controls the tractor such that the trailer moves on the target path. Therefore, in the backward movement assistance, the feedforward control and the feedback control for steering the tractor become complex.

According to the towing assistance apparatus in the embodiment, the target curvature K_{2FF} of the trailer 20 used for the feedforward control is converted into the target curvature K_{1FF} of the tractor 10 based on the target path TP, and the target curvature K_{1FF} is converted into the target steering angle δ*_{sw} of the tractor 10. Accordingly, it is possible to assist the backward towing of the tractor 10 with a simple steering control logic. Accordingly, calculation cost of the towing assistance apparatus 30 can be reduced.

According to the towing assistance apparatus in the embodiment, the lateral deviation e_{y} and the yaw angle deviation e_{θ} from the target path TP of the trailer 20 are calculated from the coordinates of the trailer 20 and the hitch angle ϕ that is the coupling angle between the trailer 20 and the tractor 10, and the target curvature K_{1FF} to which the target curvature K_{1FB} of the tractor 10 used for the feedback control is added is converted into the target steering angle δ*_{sw} of the tractor 10 based on the lateral deviation e_{y} and the yaw angle deviation e_{θ} of the trailer 20.

By performing the feedforward control and the feedback control in this manner, it is possible to assist the backward towing of the tractor 10 more precisely. Since the feedback control is performed only based on the lateral deviation e_{y} and the yaw angle deviation e_{θ} of the trailer 20, gain adjustment thereof is facilitated.

### Modification

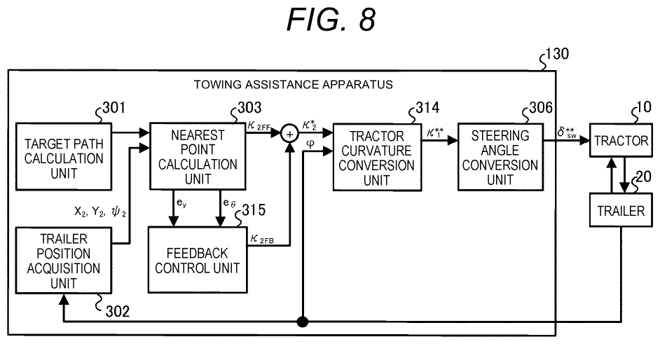

Next, a towing assistance apparatus 130 according to a modification of the embodiment will be described with reference to FIG. 8. The towing assistance apparatus 130 in the modification is different from the embodiment described above in that the target curvature of the tractor 10 is calculated based on target curvature K_{2FB} of the feedback control for the trailer 20 in addition to the hitch angle φ that is the coupling angle between the tractor 10 and the trailer 20 and the target curvature K_{2FF} of the feedforward control for the trailer 20.

FIG. 8 is a block diagram showing an example of a functional configuration of the towing assistance apparatus 130 according to the modification of the embodiment. Iₙ FIG. 8, configurations similar to those in the above-described embodiment are denoted by the same reference signs, and description thereof may be omitted.

As shown in FIG. 8, the towing assistance apparatus 130 includes a tractor curvature conversion unit 314 and a feedback control unit 315 as functional units instead of the tractor curvature conversion unit 304 and the feedback control unit 305.

The feedback control unit 315 in the modification calculates and outputs the target curvature K_{2FB} of the trailer 20 instead of the target curvature K_{1FB} of the tractor 10 calculated by the feedback control unit 305 in the above-described embodiment.

The target curvature K_{2FB} of the trailer 20 is target curvature of the trailer 20 when the feedback control for correcting the trailer position P₂ (see FIG. 5 described above) is performed, and is calculated using the following equation (2) using the lateral deviation e_{y} and the yaw angle deviation e_{θ} of the trailer 20 contained in the nearest point Pₙ calculated by the nearest point calculation unit 303.

$${κ}_{2 FB} = {κ}_{1} {e}_{y} + {κ}_{2} {e}_{θ} \qquad ( 2 )$$

A gain k₁ in equation (2) is a value that amplifies the lateral deviation e_{y} of the trailer 20 when the feedback control for correcting the trailer position P₂ is performed. A gain k₂ in equation (2) is a value that amplifies the yaw angle deviation e_{θ} of the trailer 20 when the feedback control for correcting the trailer position P₂ is performed.

The gains k₁ and k₂ may be varied under various situations, and fixed values may be used for the gains k₁ and k₂. The gains k₁ and k₂ may be values that reduce the lateral deviation e_{y} and the yaw angle deviation ee, respectively.

The target curvature K_{2FB} of the trailer 20 used for the feedback control for correcting the trailer position P₂ based on the lateral deviation e_{y} and the yaw angle deviation e_{θ} of the trailer 20 is an example of fourth target curvature.

The tractor curvature conversion unit 314 in the modification converts target curvature K′2 of the trailer 20, which is obtained by summing up the target curvature K_{2FF} of the trailer 20 used for the feedforward control for correcting the trailer position P₂ and the target curvature K_{2FB} of the trailer 20 used for the feedback control, into target curvature K**₁ of the tractor 10.

The target curvature K**₁ of the tractor 10 is calculated using the following equation (3) using the target curvature K′₂ of the trailer 20 and the hitch angle φ that is the coupling angle between the tractor 10 and the trailer 20.

$${κ}_{1}^{**} = \frac{tan φ - {κ}_{2}^{*} {l}_{2}}{{κ}_{2}^{*} {l}_{h} {l}_{2} tan φ + {l}_{n}} \qquad ( 3 )$$

As described above, the distances Iₙ and I₂ in equation (3) are the distance from the midpoint of the axle of the rear wheels 14R of the tractor 10 to the hitch ball 19 and the distance from the hitch ball 19 to the midpoint of the axle of the wheels 24 of the trailer 20 (see FIG. 7 described above), respectively.

The tractor curvature conversion unit 314 is an example of the first conversion unit, and the target curvature K**₁ of the tractor 10 obtained from the target curvature K_{2FF} and the target curvature K_{2FB} of the trailer 20 is an example of the fourth target curvature.

The steering angle conversion unit 306 calculates a target steering angle δ**_{sw} of the tractor 10 based on the target curvature K**₁ of the tractor 10 and outputs the target steering angle δ**_{sw} to the tractor 10 as in the above-described embodiment. The target steering angle δ**_{sw} of the tractor 10 is a steering angle to be taken by the tractor 10 in order to cause the tractor 10 to travel on a path having the target curvature K**₁.

A difference between the target steering angle δ**_{sw} and the target steering angle δ**_{sw} in the above-described embodiment is that the target steering angle δ**_{sw} described above is calculated based on the target curvature K_{1FF} and K_{1FB} of the tractor 10, whereas the target steering angle δ**_{sw} in the modification is calculated based on the target curvature K_{2FF} and K_{2FB} of the trailer 20.

Iₙ other words, the towing assistance apparatus 30 in the above-described embodiment calculates the target curvature K′1 of the tractor 10 based on the target curvature K_{1FF} and K_{1FB} of the tractor 10, and converts the target curvature K′1 to the target steering angle δ*_{sw} of the tractor 10, whereas the towing assistance apparatus 130 in the modification calculates the target curvature K**₁ of the tractor 10 based on the target curvature K_{2FF} and K_{2FB} of the trailer 20, and converts the target curvature K**₁ to the target steering angle δ**_{sw} of the tractor 10.

According to the towing assistance apparatus 130 in the modification, the lateral deviation e_{y} and the yaw angle deviation e_{θ} from the target path TP of the trailer 20 are calculated from the coordinates of the trailer 20 and the hitch angle φ that is the coupling angle between the trailer 20 and the tractor 10, and the target curvature K_{2FF} of the trailer 20 used for the feedforward control to which the target curvature K_{2FB} of the trailer 20 used for the feedback control is added is converted into the target steering angle δ**_{sw} of the tractor 10 based on the lateral deviation e_{y} and the yaw angle deviation e_{θ} of the trailer 20.

Iₙ this way, the tractor 10 is controlled based on the target curvature K_{2FF} and the target curvature K_{2FB} of the trailer 20 related to the feedforward control and the feedback control, and thus the backward towing of the tractor 10 can be assisted more precisely. By adding the target curvature K_{2FF} of the trailer 20 related to the feedback control, it is possible to perform the appropriate feedback control according to a size of the trailer 20 and improve stability of movement of the trailer 20 according to the target path.

A towing assistance apparatus according to an embodiment is a towing assistance apparatus that assists backward traveling of a towing vehicle towing a towed vehicle, the towing assistance apparatus including: a target path calculation unit configured to calculate a target path on which the towed vehicle is to be moved; an acquisition unit configured to acquire coordinates of the towed vehicle in a planar coordinate system and a coupling angle between the towed vehicle and the towing vehicle; a calculation unit configured to calculate first target curvature that is target curvature of the towed vehicle used for feedforward control based on the target path; a first conversion unit configured to convert the first target curvature into second target curvature that is target curvature of the towing vehicle; and a second conversion unit configured to convert the second target curvature into a target steering angle of the towing vehicle.

The towing assistance apparatus according to the embodiment can perform assistance during backward towing with a simple steering control logic.

The principles, preferred embodiment and mode of operation of the present invention have been described in the foregoing specification. However, the invention which is intended to be protected is not to be construed as limited to the particular embodiments disclosed. Further, the embodiments described herein are to be regarded as illustrative rather than restrictive. Variations and changes may be made by others, and equivalents employed, without departing from the spirit of the present invention. Accordingly, it is expressly intended that all such variations, changes and equivalents which fall within the spirit and scope of the present invention as defined in the claims, be embraced thereby.

What is claimed is:

1. A towing assistance apparatus that assists backward traveling of a towing vehicle towing a towed vehicle, the towing assistance apparatus comprising:
a target path calculation unit configured to calculate a target path on which the towed vehicle is to be moved;
an acquisition unit configured to acquire coordinates of the towed vehicle in a planar coordinate system and a coupling angle between the towed vehicle and the towing vehicle;
a calculation unit configured to calculate first target curvature that is target curvature of the towed vehicle used for feedforward control based on the target path;
a first conversion unit configured to convert the first target curvature into second target curvature that is target curvature of the towing vehicle; and
a second conversion unit configured to convert the second target curvature into a target steering angle of the towing vehicle.

2. The towing assistance apparatus according to claim 1, wherein
the calculation unit calculates, based on the coordinates of the towed vehicle and the coupling angle, deviation of the towed vehicle from the target path,
the towing assistance apparatus further comprises a feedback control unit configured to calculate third target curvature that is target curvature of the towing vehicle used for feedback control based on the deviation of the towed vehicle, and
the second conversion unit converts the second target curvature, to which the third target curvature is added, to the target steering angle.

3. The towing assistance apparatus according to claim 1, wherein
the calculation unit calculates, based on the coordinates of the towed vehicle and the coupling angle, deviation of the towed vehicle from the target path,
the towing assistance apparatus further comprises a feedback control unit configured to calculate fourth target curvature that is target curvature of the towed vehicle used for feedback control based on the deviation of the towed vehicle, and
the first conversion unit converts the first target curvature, to which the fourth target curvature is added, to the second target curvature.
